(19) United States
(12) Patent Application Publication
(10) Pub. No.: US 2026/0296884 A1
(43) Pub. Date: Oct. 1, 2026

(54) HYDROGEN MANUFACTURING SYSTEM AND METHOD FOR MANUFACTURING HYDROGEN

(71) Applicants: Hyundai Motor Company, Seoul (KR); Kia Corporation, Seoul (KR)

(72) Inventors: Jung Joo PARK, Hwaseong-Si (KR); Dong Seok KO, Hwaseong-Si (KR); Jae Myung LEE, Hwaseong-Si (KR)

(21) Appl. No.: 19/287,183

(22) Filed: Jul. 31, 2025

(30) Foreign Application Priority Data
Mar. 28, 2025 (KR) 10-2025-0040582

(51) Int. Cl. C01B 3/26

(52) U.S. Cl. CPC C01B 3/26; C01B 2203/0233; C01B 2203/0283; C01B 2203/0883; C01B 2203/1241; C01B 2203/1623; C01B 2203/1676

(57) ABSTRACT

A method performed by an apparatus for manufacturing hydrogen may comprise a reforming operation comprising generating, based on a reaction of methane and water, a first gas comprising hydrogen and carbon monoxide, a water-gas shift operation comprising generating a second gas comprising hydrogen by reacting the carbon monoxide in the first gas with the water, wherein the first gas is supplied to the water-gas shift operation, a heat exchange operation comprising exchanging heat between a portion of a supply gas and the first gas, a reforming temperature adjusting operation comprising determining whether a methane shift rate is lowered and adjusting a temperature of a reforming reaction, and a flow rate adjusting operation comprising adjusting a temperature of the first gas using a valve.

### CROSS-REFERENCE TO RELATED APPLICATION

This application claims the benefit of priority to Korean Patent Application No. 10-2025-0040582, filed in the Korean Intellectual Property Office on Mar. 28, 2025, the entire contents of which are incorporated herein by reference.

### TECHNICAL FIELD

The present disclosure relates to a method for manufacturing hydrogen, by which degradation of an activity of a catalyst is prevented by adjusting temperature during a steam-methane reforming reaction, and a temperature of a gas supplied to a water-gas shift reaction is controlled through a heat exchange, and a hydrogen control system using the same.

### BACKGROUND

The matters described in this Background section are only for enhancement of understanding of the background of the disclosure, and should not be taken as acknowledgment that they correspond to prior art already known to those skilled in the art.

Hydrogen gas is in the spotlight as an eco-friendly energy source, and various methods of producing hydrogen gas are considered. Among the methods for manufacturing hydrogen gas, a steam methane reforming (SMR) method of manufacturing hydrogen by bringing methane and water into reaction with each other may be used, and the steam methane reforming method may enable mass-production of hydrogen. The steam methane reforming method uses nickel (Ni) that may be a relatively inexpensive transition metal as a catalyst, but the catalyst including nickel has a problem in that carbon monoxide (CO) generated during the methane reforming reaction is adsorbed on a surface thereof, and thus, an activity thereof deteriorates.

As an alternative to the problem caused by degradation of the activity of the catalyst, a hydrocarbon reforming catalyst additive containing an oxide of an alloy of alkali metal and titanium may be considered. However, when an additive as a catalyst additive is used, an economic feasibility may decrease due to an additional amount, such as the purchase costs of the additive, or reaction conditions, such as temperature, may change during a steam methane reforming reaction, resulting in lowering of a methane shift rate.

In addition, the activity of a catalyst in a reformer may be estimated by calculating a methane shift rate based on a measured reaction temperature in the reformer. However, in a large reformer of a specific size or more, an accuracy of predicting the activity of a catalyst may be poor due to a small change in the temperature of the reaction.

For regenerating a catalyst with a decreased activity in the reformer, carbon adsorbed on a surface of a catalyst may be made to react with steam to be converted into carbon dioxide by supplying steam into the reformer. However, the solidified carbon adsorbed on the surface of the catalyst may have low reactivity with steam, or some of the catalysts may be sintered, which further accelerates a decrease in the activity of the catalyst.

Therefore, a hydrogen manufacturing method and a hydrogen production system using the same, by which the methane shift rate may be increased and the catalyst lifespan extended by preventing degradation of the reforming catalyst's activity, are under consideration.

### SUMMARY

The present disclosure has been made to solve the above-mentioned problems.

An example of the present disclosure provides a method for manufacturing hydrogen, by which a methane shift rate may be increased by adjusting a temperature of a reforming reaction to prevent excessive degradation of an activity of a reforming catalyst, and degradation of hydrogen production efficiency may be prevented by adjusting a temperature of a gas supplied to a water-gas shifter (e.g., a water-gas shift reactor, a water-gas shift reaction vessel, etc.), and a hydrogen manufacturing system using the same.

The technical problems to be solved by the present disclosure are not limited to the aforementioned problems, and any other technical problems not mentioned herein will be clearly understood from the following description by those skilled in the art to which the present disclosure pertains.

According to the present disclosure, a method performed by an apparatus for manufacturing hydrogen, the method may comprise, a reforming operation may comprise generating, based on a reaction of methane and water, a first gas may comprise hydrogen and carbon monoxide, a water-gas shift operation may comprise generating a second gas may comprise hydrogen by reacting the carbon monoxide in the first gas with the water, wherein the first gas generated in the reforming operation is supplied to the water-gas shift operation, a heat exchange operation may comprise exchanging heat between a portion of a supply gas supplied to the reforming operation and the first gas supplied to the water-gas shift operation, a reforming temperature adjusting operation may comprise determining whether a methane shift rate is lowered in the reforming operation and adjusting, based on the determining of whether the methane shift rate is lowered in the reforming operation, a temperature of a reforming reaction, wherein the methane shift rate corresponds to a rate at which the methane is converted to the hydrogen and the carbon monoxide in the reforming operation, and a flow rate adjusting operation may comprise adjusting a temperature of the first gas supplied to the water-gas shift operation by controlling, with a valve, a flow rate of the supply gas used for the heat exchange operation.

The method, wherein the reforming operation is performed at 750° C. or more and 1,000° C. or less.

The method, wherein the supply gas may comprise the water, or a mixture of the water and the methane.

The method, wherein the heat exchange operation may comprise, a first heat exchange operation of exchanging heat between the first gas generated in the reforming operation and a portion of the supply gas supplied to the reforming operation, a second heat exchange operation of exchanging heat between the heat-exchanged first gas generated in the first heat exchange operation and a portion of the supply gas supplied to the reforming operation, a third heat exchange operation of exchanging heat between the heat-exchanged first gas generated in the second heat exchange operation and a portion of the supply gas supplied to the reforming operation, and a fourth heat exchange operation of exchanging heat between the heat-exchanged first gas generated in the third heat exchange operation and a portion of the supply gas supplied to the reforming operation.

The method, wherein the adjusting of the temperature of the first gas may comprise adjusting, using the valve, a flow rate of the supply gas in each of the first heat exchange operation, the second heat exchange operation, the third heat exchange operation, and the fourth heat exchange operation.

The method, wherein the adjusting of the temperature of the first gas may comprise, based on a temperature of the first gas generated in the reforming operation, controlling, with respective valves, flow rates of the supply gas supplied to a plurality of heat exchangers used in the heat exchange operation.

The method, wherein the reforming temperature adjusting operation may comprise, determining whether a methane shift rate is lowered, by measuring a concentration of the methane in the first gas generated in the reforming operation, and increasing, based on the methane shift rate being a preset value or less, a temperature of the reaction of methane and water in the reforming operation.

The method, wherein the reforming temperature adjusting operation may comprise, increasing a temperature of the reaction of methane and water in the reforming operation based on a cumulative time of the reaction in the reforming operation being a preset value or more.

The method, wherein the flow rate adjusting operation may comprise adjusting a temperature of the first gas to 150° C. or more and 350° C. or less by adjusting, using the valve, a flow rate of the supply gas.

According to the present disclosure, an apparatus for manufacturing hydrogen, the apparatus may comprise, reformer reaction vessels configured to generate, based on a reaction of methane and water, a first gas may comprise hydrogen and carbon monoxide, a water-gas shift reaction vessel configured to generate a second gas may comprise hydrogen by reacting the carbon monoxide in the first gas with the water, a plurality of heat exchangers configured to exchange heat between a portion of supply gas supplied to the reformer reaction vessels and the first gas supplied to the water-gas shift reaction vessel, a temperature control circuit configured to control a methane shift rate by adjusting reaction temperatures in the reformer reaction vessels, and a control circuit configured to control flow rates of supply gas supplied to the plurality of heat exchangers, respectively, by operating valves associated with the respective heat exchangers.

The apparatus, wherein the control circuit is configured to adjust a temperature of the first gas supplied to the water-gas shift reaction vessel to 150° C. or more and 350° C. or less by controlling the flow rates of the supply gases supplied to the plurality of heat exchangers.

The apparatus, wherein the plurality of heat exchangers comprise at least three heat exchangers.

The apparatus, wherein the plurality of heat exchangers comprise, a first heat exchanger configured to exchange heat between the first gas generated in the reformer reaction vessels and a portion of the supply gas supplied to the reformer reaction vessels, a second heat exchanger configured to exchange heat between the heat-exchanged first gas generated in the first heat exchanger and a portion of the supply gas supplied to the reformer reaction vessels, a third heat exchanger configured to exchange heat between the heat-exchanged first gas generated in the second heat exchanger and a portion of the supply gas supplied to the reformer reaction vessels, and a fourth heat exchanger configured to exchange heat between the heat-exchanged first gas generated in the third heat exchanger and a portion of the supply gas supplied to the reformer reaction vessels.

The apparatus, may comprise, a temperature sensor configured to measure a temperature of the first gas discharged from the reformer reaction vessels, wherein the control circuit is configured to adjust, based on the measured temperature of the first gas, a temperature of the first gas supplied to the water-gas shift reaction vessel by controlling flow rates of supply gas supplied to the plurality of heat exchangers.

The apparatus, may comprise, a gas sensor configured to measure a concentration of the methane, wherein the methane is in the first gas generated in the reformer reaction vessels.

The apparatus, wherein the supply gas may comprise water, or a mixture of water and methane.

According to the present disclosure, an apparatus for hydrogen production, the apparatus may comprise, a reformer reaction vessel configured to receive a gas may comprise methane and steam, and react the gas to produce a first gas may comprise hydrogen, carbon monoxide, and at least a portion of the methane, a sensor configured to determine that a methane-conversion rate has decreased, wherein the methane-conversion rate corresponds to a rate at which the methane in the gas is converted to the hydrogen and the carbon monoxide in the reformer reaction vessel, a temperature control circuit configured to increase, based on a determination that the methane-conversion rate has decreased, a reaction temperature in the reformer reaction vessel, a plurality of heat exchangers configured to receive the first gas from the reformer reaction vessel and transfer heat from the first gas to at least a portion of the gas, wherein the at least the portion of the gas is directed through the plurality of heat exchangers, a flow control valve assembly coupled to the plurality of heat exchangers and configured to control, based on the reaction temperature in the reformer reaction vessel, a flow rate of the at least the portion of the gas directed through the plurality of heat exchangers, and a water-gas shift reaction vessel configured to receive the first gas from the plurality of heat exchangers and convert carbon monoxide in the first gas to additional hydrogen.

The apparatus, wherein the sensor is configured to determine, based on a concentration of the at least the portion of the methane in the first gas, the methane-conversion rate.

The apparatus, wherein the sensor is configured to determine, based on a cumulative operating time of the reformer reaction vessel, the methane-conversion rate.

The apparatus, wherein the temperature control circuit is further configured to increase, based on a concentration of the at least the portion of the methane in the first gas exceeding a predetermined threshold, the reaction temperature in the reformer reaction vessel.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of adjusting a temperature of a reforming reaction according to a cumulative time of the reforming reaction;

FIG. 2 shows exemplary flowcharts of a hydrogen manufacturing system according to some example of the present disclosure;

FIG. 3 shows exemplary flowcharts of a hydrogen manufacturing system according to some example of the present disclosure;

FIG. 4 shows exemplary flowcharts of a hydrogen manufacturing system according to some example of the present disclosure; and

FIG. 5 shows an example computing system (e.g., a computing device for hydrogen production or manufacturing, a computing device of a vehicle or any other apparatus associated with hydrogen fuel system).

### DETAILED DESCRIPTION

Hereinafter, the present disclosure will be described in detail.

In the specification, when a portion “comprises” a component, it means that it can further include other component, without excluding other components unless for example stated otherwise.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The terminology used herein is for the purpose of describing particular examples only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation, and can be implemented by hardware components or software components and combinations thereof.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICS, DSPs, digital signal processing devices, programmable logic devices, field-programmable gate arrays, processors, microprocessors, electronic controllers, microcontrollers, devices, or computers or combinations thereof designed to perform the functions described in the present disclosure.

### Method for Manufacturing Hydrogen

The method for manufacturing hydrogen according to the present disclosure includes a reforming operation, a water-gas shift operation, a heat exchange operation, a reforming temperature adjusting operation, and a flow rate adjusting operation.

### Reforming Operation

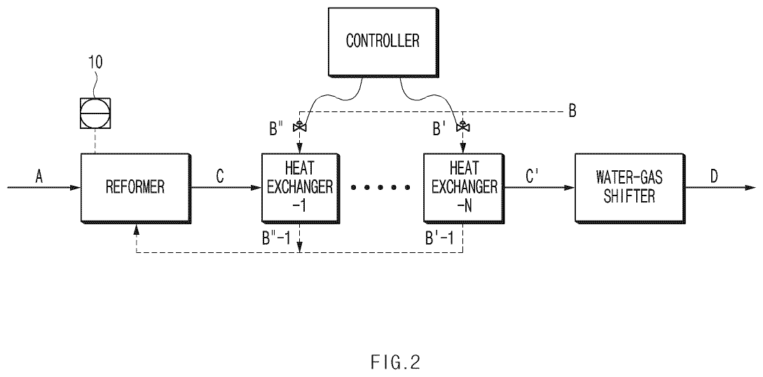

In the operation, methane and water react with each other to generate a first gas including hydrogen and carbon monoxide. For example, in the reforming operation, steam methane reforming (SMR) (CH₄+H₂O→3H₂+CO) of methane “A” and supply gas “B” proceeds to generate a first gas “C” containing hydrogen and carbon monoxide (e.g., from natural gas, landfill gas, anaerobic digester gas, or synthetic gas, etc.) (reference FIG. 2).

The methane supplied in the reforming operation may be used without limitation as long as it may be generally used to produce hydrogen through steam methane reforming, and, for example, may be included in city gas or bio-gas. Various examples, the methane supplied to the reforming operation may be derived from city gas (e.g., liquefied natural gas or pipeline gas) and/or bio-gas (e.g., landfill gas, agricultural waste gas, or food-waste-derived gas, etc.).

For example, the water used in the reforming operation may include ultra-pure water, deionized water, or demineralized water, etc., depending on the desired catalyst lifetime and process efficiency.

Because the reforming reaction in the operation is an endothermic reaction, heat required for the reforming reaction may be supplied in the reforming operation. The supply of heat as described above may be used with no particular limitation in any conventional method, and for example, may include a burner, a heat exchanger, a radiant tube heater, an electric heater, or a hot gas generator, etc.

The temperature in the reforming operation may be 750° C. or more, 760° C. or more, 780° C. or more, 800° C. or more, 1,000° C. or less, 980° C. or less, 970° C. or less, 960° C. or less, or 950° C. or less. If the temperature in the reforming operation is within the above range, undesired side reactions such as carbon deposition (i.e., coking), may be suppressed so that a decrease in the activity of the catalyst may be prevented and the efficiency of the methane reforming reaction may be improved, and thus, the hydrogen production yield rate may be improved.

Furthermore, the reforming operation may be performed in the presence of a catalyst for a steam methane reforming reaction. The catalyst for the steam methane reforming reaction is commonly used for reforming reactions, and may be used with no particular limitation as long as it may be manufactured and/or purchased. Examples of such catalysts include nickel-based catalysts, nickel-magnesium-alumina catalysts, or noble metal-supported catalysts such as Rh/Al₂O₃, Ru/CeO₂, or Pt/ZrO₂, etc.

The temperature in the reforming operation may be adjusted depending on the activity of the catalyst for the steam methane reforming reaction, that is, a change in a methane shift rate. For example, when the methane shift rate is lowered, the temperature in the reforming operation may be increased to improve the methane shift rate. Such adjustment may be performed stepwise or continuously based on feedback from a methane concentration sensor or a catalyst degradation model.

Furthermore, a molar ratio of the methane and the water supplied in the reforming operation may be 1:2.0 or more and 1:5.0 or less. If the amount of the water supplied to the reforming operation is within the above range, the yield rate of the methane reforming reaction may be improved, and undesirable side reactions such as pyrolysis or carbon deposition may be suppressed by reducing a pyrolysis reaction of the methane, so that a decrease in the activity of the catalyst may be prevented.

The supply gas supplied in the reforming operation may be used without particular limitation as long as it may be supplied to the steam methane reforming reaction (SMR), and, for example, may be a mixture of at one or more methane-containing gas selected from the group consisting of city gas, bio-gas, or methane, and water. Additional examples include reformed tail gas from hydrogen purification, liquefied petroleum gas (LPG), or synthetic natural gas (SNG), etc.

### Water-Gas Shift Operation

In the operation, a second gas is generated through a reaction of the carbon monoxide included in the first gas and the water. For example, the second gas may include hydrogen and carbon dioxide (e.g., in concentrations determined by reaction temperature, catalyst activity, or steam-to-carbon ratio, etc.).

The reaction in the water-gas shift operation may be a water-gas shift (WGS) reaction (CO+H₂O→CO₂+H₂), for example, which may be an exothermic reaction that occurs downstream of the reforming step.

Furthermore, the water-gas shift operation may be performed in the presence of a WGS catalyst that promotes a water-gas shift (WGS) reaction, and the WGS catalyst is commonly used for the WGS, and may be used with no special limitation as long as it may be manufactured and/or purchased. Examples include iron-chromium-based catalysts, copper-zinc-alumina catalysts, or ceria-supported noble metal catalysts (e.g., Pt/CeO₂ or Au/CeO₂/etc.).

The temperature in the water-gas shift operation may be 150° C. or more, 180° C. or more, 200° C. or more, 350° C. or less, 320° C. or less, or 300° C. or less. Furthermore, the manufactured second gas may have a temperature of 150° C. or more, 180° C. or more, 200° C. or more, 350° C. or less, 320° C. or less, or 300° C. or less. Accordingly, the second gas may include water in the form of water steam and gaseous carbon dioxide (e.g., 5-25% H₂O and 10-25% CO₂, depending on equilibrium conditions and reaction stage, etc.).

When the temperature in the reforming operation is increased as described above, the temperature of the first gas discharged in the reforming operation becomes high, and thus the temperature of the first gas supplied in the water-gas shift operation is also high, which may exceed an optimal operating range of the WGS catalyst and cause a decrease in a water-gas shift reaction efficiency. Accordingly, the present disclosure solves the above problem by exchanging heat between a portion of the supply gas supplied in the reforming operation and the first gas supplied in the water-gas shift operation to adjust the temperature of the first gas supplied in the water-gas shift operation (e.g., by using one or more shell-and-tube, plate-fin, or recuperative heat exchangers, etc.).

### Heat Exchange Operation

In the operation, a portion of the supply gas supplied in the reforming operation and the first gas supplied in the water-gas shift operation exchange heat. For example, degradation of an efficiency of the water-gas shift reaction may be prevented by exchanging heat between the supply gas supplied in the reforming operation at a relative low temperature and the first gas supplied in the water-gas shift operation at a relatively high temperature to adjust the temperature of the first gas supplied in the water-gas shift operation (e.g., to maintain WGS inlet temperature within a target range, avoid catalyst overheating, or optimize CO conversion, etc.).

For example, the heat exchange operation may include a first heat exchange operation of exchanging heat between the first gas discharged in reforming operation and a portion of the supply gas supplied in reforming operation (e.g., using a counterflow shell-and-tube heat exchanger, a plate heat exchanger, or a recuperative heat exchanger, etc.); a second heat exchange operation of exchanging heat between the heat-exchanged first gas discharged in first heat exchange operation and a portion of the supply gas supplied in reforming operation (e.g., via a subsequent-stage plate-fin heat exchanger, spiral heat exchanger, or multi-pass tube bundle, etc.); a third heat exchange operation of exchanging heat between the heat-exchanged first gas discharged in second heat exchange operation and a portion of the supply gas supplied in reforming operation (e.g., using an additional shell-and-tube exchanger, a compact microchannel heat exchanger, or a crossflow unit, etc.); and a fourth heat exchange operation of exchanging heat between the heat-exchanged first gas discharged in third heat exchange operation and a portion of the supply gas supplied in reforming operation (e.g., using a staged counterflow configuration, nested shell-and-tube designs, or cascade cooling loops, etc.).

For example, the heat exchange in the operation may be performed using a plurality of heat exchangers, and for example, may involve three or more, four or more, or six or less heat arranged in series, parallel, or hybrid exchangers (e.g., configurations, depending on thermal load distribution and system design constraints, etc.). As described above, when the heat exchange in the operation is performed using a plurality of heat exchangers, the temperature of the first gas supplied in the water-gas shift operation may be more effectively controlled by controlling flow rates of the supply gases supplied in the respective heat exchangers (e.g., via flow control valves, proportional-integral controllers, or thermocouple-based feedback loops, etc.).

### Reforming Temperature Adjusting Operation

As described above, the catalyst for the reforming reaction used in the reforming operation may have a decreased activity due to cocking (e.g., carbon deposition on active sites, sintering of metal particles, or structural collapse of the catalyst support, etc.), and thus, the methane shift rate in the reforming operation may be decreased. The decrease in the methane shift rate due to the decrease in the activity of the catalyst may be solved by adjusting the temperature of the reforming operation. To this end, the method for manufacturing hydrogen according to the present disclosure includes a reforming temperature adjusting operation of determining whether the methane shift rate is lowered in the reforming operation and then adjusting the temperature of the reforming reaction.

In an example, the operation may include a shift rate measuring operation of determining whether a methane shift rate is lowered, by measuring a concentration of the methane in the first gas discharged in the reforming operation; and a reforming temperature adjusting operation of increasing a temperature of the reforming reaction in the reforming operation if a measured methane shift rate in shift rate measuring operation is at or below a preset value (e.g., 90%, 85%, or 80% conversion efficiency, etc.).

For example, when the methane shift rate in reforming operation is lowered, the concentration of the methane in the first gas discharged in reforming operation increases. Accordingly, through the measurement of the concentration of the methane in the first gas discharged in the reforming operation, it is possible to measure whether the methane shift rate in the reforming operation is lowered (e.g., by using a gas analyzer, non-dispersive infrared sensor, or online gas chromatography, etc.).

The preset value of the methane shift rate in reforming temperature adjusting operation may be a threshold value arbitrarily set by a user during the manufacturing of the hydrogen, and generally, any target value for the methane shift rate during the manufacturing of the hydrogen may be used without particular limitation (e.g., a design minimum shift efficiency required to maintain downstream WGS reactor loading within optimal bounds, etc.).

For example, in reforming temperature adjusting operation, when the methane shift rate measured in shift rate measuring operation is the preset value or less, the methane shift rate may be improved by increasing the temperature of the reforming reaction in the reforming operation (e.g., in 10-20° C. increments, up to a maximum safe threshold for reactor materials, etc.).

As another example, the operation may include a reforming temperature adjusting operation of increasing the temperature of the reforming reaction in the reforming operation if the cumulative time of the reaction in the reforming operation is the preset value or more. For example, when the cumulative time of the reaction in the reforming operation is increased to the preset value or more, it may be determined that the activity of the catalyst for the reforming reaction will be decreased, and the methane shift rate may be improved by increasing the temperature of the reforming reaction in the reforming operation (e.g., based on predictive maintenance models or time-based catalyst degradation curves, etc.).

For example, the preset value of the cumulative time of the reaction in the reforming operation may be a user-defined value arbitrarily set by the user during the manufacturing of hydrogen, and for example, may be a target value set by utilizing data on deterioration characteristics of the catalyst according to the cumulative reaction time of the reforming reaction. For example, the preset value of the cumulative time of the reaction in the reforming operation may vary depending on catalyst type and/or reformer design, and may be, for example, 5,000 hours or more, 6,000 hours or more, 7,000 hours or more, 8,000 hours or more, 10,000 hours or more. For example, if the cumulative time of the reaction in the reforming operation is 5,000 hours, 6,000 hours or more, 7,000 hours or more, 8,000 hours, or 10,000 hours, the methane shift rate may be improved by increasing the temperature of the reforming reaction (e.g., from 780° C. to 820° C., or from 830° C. to 880° C., etc.).

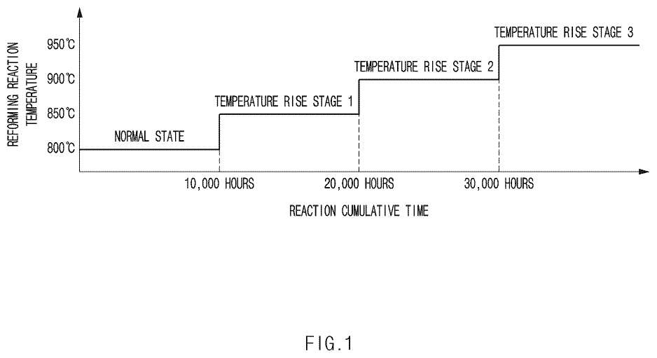

For example, referring to FIG. 1, if the reaction cumulative time is 10,000 hours or less (in the “normal state” of FIG. 1), the reaction temperature in the reforming operation may be adjusted to 780° C. or more, 790° C. or more, 800° C. or more, 830° C. or less, 820° C. or less, or 810° C. or less (e.g., depending on initial catalyst activity, reactor wall material limitations, or plant startup protocol, etc.). Furthermore, if the reaction cumulative time is more than 10,000 hours and 20,000 hours or less (in “temperature rise stage 1” in FIG. 1), the reaction temperature in the reforming operation may be adjusted to 830° C. or more, 840° C. or more, 850° C. or more, 880° C. or less, 870° C. or less, or 860° C. or less (e.g., corresponding to moderate catalyst aging or minor carbon accumulation, etc.). Furthermore, if the reaction cumulative time is more than 20,000 hours and 30,000 hours or less (in the case of “temperature rise stage 2” in FIG. 1), the reaction temperature in the reforming operation may be adjusted to 880° C. or more, 890° C. or more, 900° C. or more, 930° C. or less, 920° C. or less, or 910° C. or less (e.g., based on scheduled mid-life catalyst performance assessment, etc.). Furthermore, if the reaction cumulative time is more than 30,000 hours and 40,000 hours or less (in “temperature rise stage 3” in FIG. 1), the reaction temperature in the reforming operation may be adjusted to 930° C. or more, 940° C. or more, 950° C. or more, less than 1,000° C., 980° C. or less, or 970° C. or less (e.g., subject to metallurgical limits of reactor internals, or to maximize hydrogen output before planned catalyst replacement, etc.).

### Flow Rate Adjusting Operation

In the operation, the temperature of the first gas supplied in the water-gas shift operation is controlled by adjusting the flow rate of the supply gas supplied in the heat exchange operation with a valve. For example, due to the adjustment of the temperature of the reforming reaction in the reforming temperature adjusting operation, for example, an increase in the temperature, the temperature of the first gas discharged in the reforming operation is increased. Consequently, the temperature of the first gas supplied in the water-gas shift operation may also rise, causing the reaction temperature in the water-gas shift operation to increase. Accordingly, the present disclosure prevents reactivity and/or efficiency from deteriorating due to an increase in temperature of the water-gas shift reaction by adjusting the temperature of the first gas supplied in the water-gas shift operation to adjust the reaction temperature in the water-gas shift operation (e.g., to maintain catalyst performance, suppress side reactions, or avoid thermal stress, etc.).

For example, as described above, when the heat exchange operation is performed using a plurality of heat exchangers, in the operation, the flow rates of the supply gas supplied to the plurality of heat exchangers may be adjusted by valves. For this reason, the temperature of the first gas supplied in the water-gas shift operation may be effectively controlled. For example, when the heat exchange operation includes the first heat exchange operation, the second heat exchange operation, the third heat exchange operation and the fourth heat exchange operation, the flow rates of the supply gases supplied in the first heat exchange operation, the second heat exchange operation, the third heat exchange operation and the fourth heat exchange operation may be adjusted by valves in the flow rate adjusting operation (e.g., with feedback control using temperature sensors, programmable logic controllers, or flow actuators, etc.).

Furthermore, in the flow rate adjusting operation, the temperature of the first gas supplied in the water-gas shift operation may be dynamically controlled by adjusting the flow rates of the supply gases supplied to the plurality of heat exchangers based on the temperature of the first gas discharged in the reforming operation. For example, in the flow rate adjusting operation, the temperature of the first gas supplied in the water-gas shift operation may be controlled by adjusting the flow rates of the supply gases supplied in the first heat exchange operation, the second heat exchange operation, the third heat exchange operation and the fourth heat exchange operation based on the temperature of the first gas discharged in the reforming operation (e.g., using temperature intervals such as 780° C.-820° C., 820° C.-880° C., etc., with pre-set flow split ratios for each stage).

For example, in the flow rate adjusting operation:

If the temperature of the first gas discharged in the reforming operation is 780° C. or more and less than 820° C., 98 volume % or more of the supply gas supplied in the reforming operation may be supplied in the fourth heat exchange operation (e.g., to minimize unnecessary heat exchange stages if temperatures of reformate gas are within a manageable range, thereby improving system efficiency and reducing pressure drop, etc.);

If the temperature of the first gas discharged in the reforming operation is 820° C. or more and less than 880° C., 70 volume % or more and less than 80 volumes of the supply gas supplied in the reforming operation may be supplied in the fourth heat exchange operation, and 20 volumes or more and less than 30 volume % of the supply gas supplied in the reforming operation may be supplied in the third heat exchange operation (e.g., to ensure sufficient cooling of the reformate while maintaining adequate thermal recovery to preheat the incoming feed gas, etc.);

If the temperature of the first gas discharged in the reforming operation is 880° C. or more and less than 930° C., 40 volume % or more and 70 volumes or less of the supply gas supplied in the reforming operation may be supplied in the fourth heat exchange operation, 30 volume % or more and 40 volume % or less of the supply gas supplied in the reforming operation may be supplied in the third heat exchange operation, and 20 volume % or less of the supply gas supplied in the reforming operation may be supplied in the second heat exchange operation (e.g., to gradually reduce the temperature of the high-temperature reformate while minimizing thermal stress and ensuring effective preheating of incoming feed gas, etc.); and

If the temperature of the first gas discharged in the reforming operation is 930° C. or more and less than 1,000° C., 40 volume % or more and 70 volume % or less of the supply gas supplied in the reforming operation may be supplied in the fourth heat exchange operation, 20 volume % or more and 30 volume % or less of the supply gas supplied in the reforming operation may be supplied in the third heat exchange operation, 10 volume % or more and 20 volume % or less of the supply gas supplied in the reforming operation may be supplied in the second heat exchange operation, and 10 volume % or less of the supply gas supplied in the reforming operation may be supplied in the first heat exchange operation (e.g., to ensure the WGS inlet gas remains below thermal degradation thresholds for typical low-temperature shift catalysts, etc.).

Furthermore, in the operation, the temperature of the first gas supplied in the water-gas shift operation may be adjusted to 150° C. or more and 350° C. or less by adjusting a flow rate of the supply gas supplied in the heat exchange operation by adjusting a valve (e.g., to maintain optimal catalyst activity, prevent thermal degradation, or stabilize downstream hydrogen purification, etc.). For example, in the operation, the temperature of the first gas supplied in the water-gas shift operation may be adjusted to 160° C. or more, 180° C. or more, 200° C. or more, 340° C. or less, 320° C. or less, or 300° C. or less by controlling a valve (e.g., to match the optimal operating range of WGS catalysts such as Cu/Zn/Al or Fe/Cr formulations, etc.).

According to the method for manufacturing hydrogen according to the present disclosure described above, excessive degradation of the activity of the reforming catalyst may be prevented and the methane shift rate may be increased by adjusting the temperature of the reforming reaction. As a result, the operational lifespan of the reforming catalyst may be extended (e.g., by delaying catalyst replacement, reducing regeneration frequency, or minimizing sintering and carbon deposition, etc.), thereby improving overall economic performance.

### Hydrogen Manufacturing System

The hydrogen manufacturing system according to the present disclosure includes reformers (e.g., reforming reactors, reformer reaction vessels, steam methane reforming reactors, etc.), a water-gas shifter (e.g., a water-gas shift reactor, a water-gas shift reaction vessel, etc.), a plurality of heat exchangers, a temperature adjuster (e.g., a temperature control circuit), and a controller (e.g., control circuit, implemented using programmable logic control circuitry, distributed control systems, or embedded control circuitry, etc.).

Referring to FIG. 2, the hydrogen manufacturing system according to the present disclosure is supplied with a supply gas “B” including methane “A” and water, and includes the reformers, the water-gas shifter, the plurality of heat exchangers, a temperature adjuster 10, and the controller. For example, a first gas “C” discharged from the reformers may include hydrogen (H₂) and carbon monoxide (CO), and a second gas “D” discharged from the water-gas shifter may include hydrogen (H₂), carbon dioxide (CO₂) and water (H₂O) (e.g., in varying concentrations depending on reaction conversion efficiency, steam-to-carbon ratio, and operating temperature, etc.).

In the reformers, a steam methane reforming (SMR) reaction (CH₄+H₂O→3H₂+CO), an endothermic reaction, in which methane and water react with each other, is performed. Furthermore, in the water-gas shifter, a water-gas shift (WGS) reaction (CO+H₂O→CO₂+H₂), an exothermic reaction, is performed. When a methane shift rate in the reformer decreases, concentrations of methane in the first gas “C” discharged from the reformer increases, and concentrations of hydrogen and carbon monoxide decrease. Accordingly, the hydrogen manufacturing system according to the present disclosure is solved by adjusting the temperature of the reformers after determining whether the methane shift rate was lowered. For example, the temperature of the first gas discharged from the reformers and supplied to the water-gas shifter may be altered by adjusting the temperature of the reformer, which in turn affect the water-gas shift reaction rate in the water-gas shifter to change. Thus, to prevent undesirable temperature increases in the WGS reactor and maintain reaction efficiency, the hydrogen manufacturing system controls the temperature of the first gas supplied to the water-gas shifter using the plurality of heat exchangers (e.g., shell-and-tube exchangers, compact heat exchangers, or plate-fin exchangers, etc.).

### Reformers

In the reformer, methane and water react with each other to generate a first gas including hydrogen and carbon monoxide. Referring to FIG. 2, the supply gas “B” including methane “A” and water are supplied to the reformer, and a steam methane reforming (SMR) reaction (CH₄+H₂O→3H₂+CO) as described above is performed to generate the first gas “C” including hydrogen and carbon monoxide (e.g., with hydrogen yield influenced by temperature, catalyst activity, and steam-to-carbon ratio, etc.).

The supply gas B supplied in the reformers may be water (e.g., steam, water steam, water vapor) or a mixture of water and methane. For example, the water supplied in the reformers may be ultrapure water (e.g., deionized, reverse-osmosis treated, or distilled water, etc.).

Furthermore, the supply gas supplied to the reformer may be pressurized and supplied, and a compression pump may be used for this purpose. For example, a target pressure may be 10 bar or less, 9 bar or less, 4 bar or more, or 6 bar or more (e.g., depending on reactor design, throughput requirements, or compressor capacity, etc.), but is not limited thereto.

The methane “A” supplied in the reformers may be used without limitation as long as it may be generally used to produce hydrogen through steam methane reforming, and, for example, may be included in city gas and/or bio-gas. For example, the methane supplied to the reformers may be derived from city gas and/or bio-gas. For instance, the methane may be derived from natural gas pipelines, liquefied natural gas (LNG), landfill gas, anaerobic digester gas, or synthetic natural gas (SNG), etc.

Furthermore, the water supplied to the reformers may be larger than an amount of water, for example, used for the SMR in the reformers and am amount of water, for example, used for the WGS in the water-gas shifter. For example, when the number of moles of methane is set to 1, the amount of water supplied to the reformers may be 2.0 moles or more, 2.5 moles or more, 3.0 moles or more, 3.5 moles or more, 5.0 moles or less, 4.5 moles or less, or 4.0 moles or less (e.g., to suppress coking, enhance conversion efficiency, or adjust heat balance, etc.).

As described above, the water provided to the reformer may be larger than water, for example, required for the steam reforming reaction and the water-gas shift reaction, and thus, the second gas discharged from the water-gas shifter may include water (e.g., in the form of steam or as condensable moisture, depending on downstream cooling and separation conditions, etc.).

Methane supplied to the reformer may be from city gas, but is not limited thereto. Furthermore, the methane may be pressurized and supplied to the reformer, and a gas compressor may be used for this purpose. For example, a target pressure may be 10 bar or less, 9 bar or less, 4 bar or more, or 6 bar or more, depending on system specifications, gas supply network constraints, or desired throughput.

Because the reforming reaction in the reformer as described above is an endothermic reaction, the hydrogen manufacturing system may further include a heat source for supplying heat required for the reaction in the reformer. The heat source may be used with no particular limitation as long as it is generally used as a heat source during an endothermic reaction. For example, the heat source may include a burner (e.g., gas-fired or dual-fuel) and a heat exchanger (e.g., recuperative or regenerative type, etc.).

Furthermore, the reformer may include a catalyst for a steam reforming reaction. The catalyst for the steam methane reforming reaction is commonly used for reforming reactions, and may be used with no particular limitation as long as it may be manufactured and/or purchased. For example, such catalyst may include nickel-based catalysts on alumina or magnesium-alumina supports, or noble metal-based catalysts such as Rh, Ru, or Pt supported on ceria, zirconia, or other refractory oxides, etc.

### Water-Gas Shifter

The water-gas shifter generates a second gas including hydrogen by bringing the carbon monoxide in the first gas and the water into reaction with each other. For example, the second gas may include hydrogen and carbon dioxide (e.g., with compositions depending on equilibrium temperature, catalyst activity, and H₂O/CO ratio, etc.).

The reaction in the water-gas shifter may be a water-gas shift (WGS) reaction (CO+H₂O→CO₂+H₂), which is an exothermic reaction and may be used to increase hydrogen yield downstream of a reformer.

Furthermore, the water-gas shifter may include a WGS catalyst that promotes a water-gas shift (WGS) reaction, and the WGS catalyst is commonly used for the WGS, and may be used with no special limitation as long as it may be manufactured and/or purchased. For example, WGS catalysts may include iron-chromium-based catalysts for high-temperature shift (HTS) operations, and copper-zinc-alumina-based catalysts for low-temperature shift (LTS) operations (e.g., Cu/Zn/Al₂O₃ or Fe/Cr₂O₃, etc.)

### Heat Exchanger

The plurality of heat exchangers exchange heat between a portion of the gas supplied to the reformers and the first gas supplied to the water-gas shifter to adjust the temperature of the first gas supplied in the water-gas shifter. For example, degradation of an efficiency of the water-gas shift reaction may be prevented by exchanging heat between the supply gas supplied to the reformers at a relative low temperature and the first gas supplied to the water-gas shifter at a relatively high temperature to adjust the temperature of the first gas supplied to the water-gas shifter (e.g., via counterflow or crossflow heat exchanger configurations, etc.).

For example, the number of heat exchangers may be 3 or more, 4 or more, 6 or less, or 5 or less (e.g., based on heat recovery targets, system modularity, or spatial constraints, etc.).

For example, the heat exchanger may include a first heat exchanger that exchanges heat between the first gas discharged from the reformers and portions of the supply gases supplied to the reformers; a second heat exchanger that exchanges heat between the heat-exchanged first gas discharged from the first heat exchanger and a portion of the supply gases supplied to the reformers; a third heat exchanger that exchanges heat between the heat-exchanged first gas discharged from the second heat exchanger and a portion of the supply gases supplied to the reformers; and a fourth exchanger that exchanges heat between the heat-exchanged first gas discharged from the third heat exchanger and a portion of the supply gases supplied to the reformers (e.g., in a cascaded layout with adjustable bypass paths, etc.).

As described above, when the plurality of heat exchangers are provided, the temperature of the first gas supplied to the water-gas shifter may be more effectively controlled by adjusting a flow rate of the supply gas supplied to each heat exchanger (e.g., through proportional valves, flow splitters, or active thermal management controls, etc.).

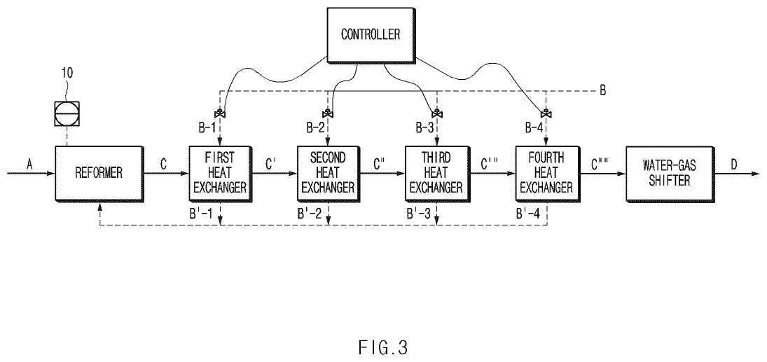

Referring to FIG. 3, the hydrogen manufacturing system according to the present disclosure may include reformers that generates a first gas, to which methane “A” and the supply gas “B are supplied and that generates a first gas through a reaction of methane “A” and water “B” (e.g., CH₄+H₂O→3H₂+CO); a first heat exchanger that exchanges heat between the first gas C discharged from the reformers and portions B-1 of the supply gases supplied to the reformers; a second heat exchanger that exchanges heat between the heat-exchanged first gas C′ discharged from the first heat exchanger and a portion B-2 of the supply gases supplied to the reformers; a third heat exchanger that exchanges heat between the heat-exchanged first gas C″ discharged from the second heat exchanger and a portion B-3 of the supply gases supplied to the reformers; a fourth exchanger that exchanges heat between the heat-exchanged first gas C′″ discharged from the third heat exchanger and a portion B-4 of the supply gases supplied to the reformers; a water-gas shifter, for example, supplied with the first gas C″″ discharged from the fourth heat exchanger and generates a second gas “D” by bringing monoxide and water into reaction with each other (e.g., under catalytic conditions at 200-300° C., depending on the shift stage); a temperature adjuster 10 that adjusts a reaction temperature in the reformers; and a controller that adjusts flow rates of supply gases supplied to the plurality of heat exchangers, respectively, with valves (e.g., based on reformer outlet temperature, desired WGS inlet temperature, or shift reaction performance metrics, etc.).

### Temperature Adjuster

As described above, the catalyst for the reformer used in the reforming operation may have a decreased activity due to cocking, which may lead to a reduction in the methane shift rate (e.g., a methane-conversion rate) in the reformer. The decrease in the methane shift rate due to the decrease in the activity of the catalyst may be addressed by adjusting the temperature of the reformer. To this end, the hydrogen manufacturing system according to the present disclosure includes a temperature adjuster that adjusts the methane shift rate by adjusting the reaction temperature in the reformers (e.g., based on methane concentration monitoring, catalyst age, or cumulative operation time, etc.).

For example, when the methane shift rate decreases due to the decrease in activity of the catalyst for reforming reaction as described above, the temperature adjuster may increase the methane shift rate by increasing the reaction temperature in the reformers (e.g., from 800° C. to 850° C. depending on degradation level, etc.).

### Gas Sensor

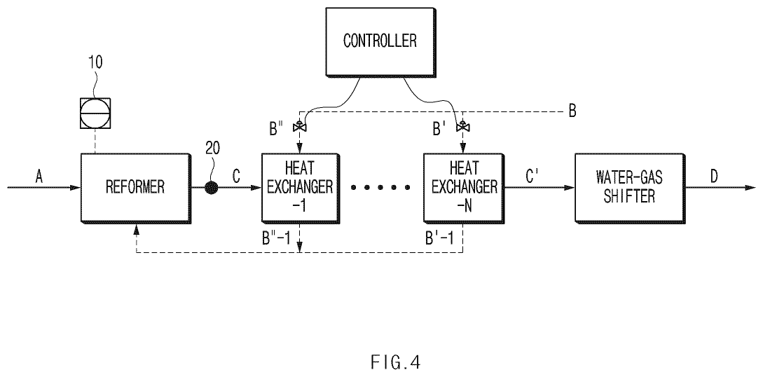

The methane shift rate as described above may be measured by measuring a concentration of methane in the first gas discharged from the reformers. To this end, the hydrogen manufacturing system according to the present disclosure may include a gas sensor 20 that measures the concentration of the methane in the first gas discharged from the reformers (see FIG. 4).

The gas sensor may be used without particular limitation as long as it is generally used to measure the concentration of a specific gas in a gas mixture. For example, the gas sensor may include a nondispersive infrared (NDIR) sensor, a tunable diode laser absorption spectroscopy (TDLAS) sensor, or a metal-oxide semiconductor sensor, etc.

The hydrogen manufacturing system according to an example of the present disclosure may measure the concentration of the methane in the first gas discharged from the reformers with the gas sensor, measure whether the methane shift rate decreases from the measured concentration of the methane in the first gas, and increase the methane shift rate by increasing the reaction temperature in the reformers with the temperature adjuster if the measured methane shift rate is a preset value or less.

For example, if the measured methane shift rate is at or below the preset value, the concentration of the methane in the first gas discharged from the reformers increases. Accordingly, the gas sensor may measure the concentration of the methane in the first gas discharged from the reformers to determine whether the methane shift rate in the reformers has decreased.

Then, the preset value of the methane shift rate may be a value arbitrarily set by a user during hydrogen production, and in general, any target value for the methane shift rate during the hydrogen production may be used without particular limitation (e.g., a threshold conversion rate of 85%, 90%, or 95%, depending on catalyst age, system calibration, or regulatory efficiency goals, etc.).

### Controller

The controller is configured to control a flow rate of the supply gas supplied to the plurality of heat exchangers using valves. With the controller, by controlling the temperature of the first gas supplied to the water-gas shifter, it is possible to prevent deterioration in reactivity and/or efficiency caused by an increase in the temperature of the water-gas shift reaction.

For example, when a decrease in the methane shift rate in the reformers is measured, the temperature of the first gas discharged from the reformers increases due to adjustment of the reaction temperature in the reformers by the temperature adjuster, specifically, due to a temperature increase. As a result, the temperature of the first gas supplied to the water-gas shifter also increases, raising the temperature in the water-gas shifter. Accordingly, the present disclosure prevents deterioration in reactivity and/or efficiency caused by increase in temperature of the water-gas shift reaction by adjusting the temperature of the first gas supplied to the water-gas shifter to adjust the temperature in the water-gas shifter using the controller.

For example, the controller adjusts the temperature of the first gas supplied to the water-gas shifter by adjusting the flow rates of the supply gases supplied to the plurality of heat exchangers using valves.

Furthermore, the controller may adjust a temperature of the first gas supplied to the water-gas shifter to a value between 150° C. and 350° C. by controlling the flow rates of the supply gases supplied to the plurality of heat exchangers, respectively. For example, the controller may adjust the temperature of the first gas supplied to the water-gas shifter to a range such as 160° C. or more, 180° C. or more, 200° C. or more, 340° C. or less, 320° C. or less, or 300° C. or less, by controlling a valve. For instance, the temperature may be controlled to approximately 190° C., 250° C., or 310° C., depending on system requirements.

For example, the system may further include a first temperature sensor (e.g., a thermocouple, RTD, or infrared thermometer) that measures the temperature of the first gas discharged from the reformers. Then, the controller may adjust the temperature of the first gas supplied to the water-gas shifter by controlling flow rates of the supply gases supplied to the plurality of heat exchangers, respectively, using valves based on the temperature (the temperature of the first gas discharged from the reformers) measured by the first temperature measurer.

For example, referring to FIGS. 1 and 3, if the temperature of the reforming reaction is between 780° C. and 820° C. (in the “normal state” of FIG. 1), at least 98 volume %, such as 98 volume %, 99 volume %, or 99.5 volume %, of the supply gas “B” supplied to the reformers may be supplied to the fourth heat exchanger.

Furthermore, if the reforming reaction temperature is between 820° C. and 880° C. (in “temperature rise stage 1” of FIG. 1), about 70 volumes to 80 volume % (e.g., 72 volume %, 75 volumes, or 78 volume %) of the supply gas “B” supplied to the reformers may be supplied to the fourth heat exchanger, and about 20 volume % to 30 volume %, such as 22 volume %, 25 volume %, or 28 volume %, of the supply gas “B” supplied to the reformers may be supplied to the third heat exchanger.

Furthermore, if the reforming reaction temperature is between 880° C. and 930° C. (in “temperature rise stage 2” of FIG. 1), about 40 volume % to 70 volume %, such as 45 volume %, 55 volumes, or 65 volume %, of the supply gas “B” supplied to the reformers may be supplied to the fourth heat exchanger, about 30 volume % to 40 volume %, such as 32 volume %, 35 volume %, or 38 volumes, of the supply gas “B” supplied to the reformers may be supplied to the third heat exchanger, and up to 20 volume %, such as 5 volume %, 10 volume %, or 15 volume %, of the supply gas “B” supplied to the reformers may be supplied to the second heat exchanger.

Furthermore, if the reforming reaction temperature is between 930° C. and 1,000° C. (in “temperature rise stage 3” of FIG. 1), about 40 volume % to 70 volume % of the supply gas “B” supplied to the reformers may be supplied to the fourth heat exchanger, about 20 volumes to 30 volume % of the supply gas “B” supplied to the reformers may be supplied to the third heat exchanger, about 10 volume % to 20 volumes of the supply gas “B” supplied to the reformers may be supplied to the second heat exchanger, and up to 10 volume %, such as 0.1 volume %, 5 volume %, or 10 volumes, of the supply gas “B” supplied to the reformers may be supplied to the first heat exchanger.

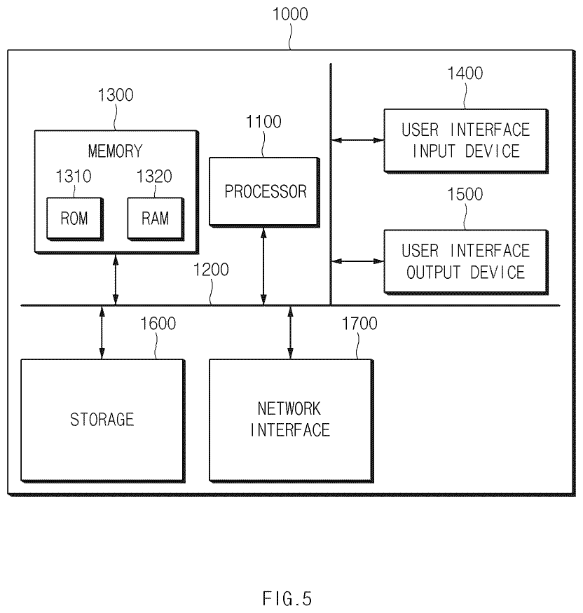

FIG. 5 shows an example computing system (e.g., a computing device for hydrogen production or manufacturing, a computing device of a vehicle or any other apparatus associated with hydrogen fuel system). One or more controllers, processors, etc. described herein, such as one or more components of a computing device for hydrogen production and any other components and devices disclosed herein, may be implemented by or in the computing system as shown in FIG. 5.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The hydrogen manufacturing system according to the present disclosure as described above may prevent hydrogen production efficiency from deteriorating by adjusting the temperature of the gas supplied to the water-gas shifter by adjusting the flow rate of the gas supplied to each of the plurality of heat exchangers.

According to the method for manufacturing hydrogen according to the present disclosure, excessive degradation of the activity of the reforming catalyst may be prevented and the methane shift rate may be increased by adjusting the temperature of the reforming reaction, and economical performance may be increased by increasing a use period of the reforming catalyst.

The hydrogen manufacturing system according to the present disclosure may prevent hydrogen production efficiency from deteriorating by adjusting the temperature of the gas supplied to the water-gas shifter by adjusting the flow rate of the gas supplied to each of the plurality of heat exchangers.

According to an example of the present disclosure, a method for manufacturing hydrogen through a steam-methane reforming reaction includes a reforming operation of generating a first gas including hydrogen and carbon monoxide through a reaction of methane and water, a water-gas shift operation of generating a second gas including hydrogen through a reaction of the carbon monoxide in the first gas and the water; a heat exchange operation of exchanging heat between a portion of the supply gas supplied in the reforming operation and the first gas supplied in the water-gas shift operation; a reforming temperature adjusting operation of determining whether a methane shift rate is lowered in the reforming operation, and then adjusting a temperature of a reforming reaction; and a flow rate adjusting operation of adjusting a temperature of the first gas supplied in the water-gas shift operation by adjusting a flow rate of a supply gas supplied in the heat exchange operation with a valve.

According to another example of the present disclosure, a system for manufacturing hydrogen through a steam-methane reforming reaction includes reformers that generates a first gas including hydrogen and carbon monoxide through a reaction of methane and water; a water-gas shifter that generates a second gas including hydrogen through a reaction of the carbon monoxide in the first gas and the water; a plurality of heat exchangers that exchanges heat between a portion of supply gas supplied to the reformers and the first gas supplied to the water-gas shifter; a temperature adjuster that adjusts a methane shift rate by adjusting reaction temperatures in the reformers; and a controller that adjusts flow rates of supply gases supplied to the plurality of heat exchangers, respectively, with valves.

What is claimed is:

1. A method performed by an apparatus for manufacturing hydrogen, the method comprising:
a reforming operation comprising generating, based on a reaction of methane and water, a first gas comprising hydrogen and carbon monoxide;
a water-gas shift operation comprising generating a second gas comprising hydrogen by reacting the carbon monoxide in the first gas with the water, wherein the first gas generated in the reforming operation is supplied to the water-gas shift operation;
a heat exchange operation comprising exchanging heat between a portion of a supply gas supplied to the reforming operation and the first gas supplied to the water-gas shift operation;
a reforming temperature adjusting operation comprising determining whether a methane shift rate is lowered in the reforming operation and adjusting, based on the determining of whether the methane shift rate is lowered in the reforming operation, a temperature of a reforming reaction, wherein the methane shift rate corresponds to a rate at which the methane is converted to the hydrogen and the carbon monoxide in the reforming operation; and
a flow rate adjusting operation comprising adjusting a temperature of the first gas supplied to the water-gas shift operation by controlling, with a valve, a flow rate of the supply gas used for the heat exchange operation.

2. The method of claim 1, wherein the reforming operation is performed at 750° C. or more and 1,000° C. or less.

3. The method of claim 1, wherein the supply gas comprises the water, or a mixture of the water and the methane.

4. The method of claim 1, wherein the heat exchange operation comprises:
a first heat exchange operation of exchanging heat between the first gas generated in the reforming operation and a portion of the supply gas supplied to the reforming operation;
a second heat exchange operation of exchanging heat between the heat-exchanged first gas generated in the first heat exchange operation and a portion of the supply gas supplied to the reforming operation;
a third heat exchange operation of exchanging heat between the heat-exchanged first gas generated in the second heat exchange operation and a portion of the supply gas supplied to the reforming operation; and
a fourth heat exchange operation of exchanging heat between the heat-exchanged first gas generated in the third heat exchange operation and a portion of the supply gas supplied to the reforming operation.

5. The method of claim 4, wherein the adjusting of the temperature of the first gas comprises adjusting, using the valve, a flow rate of the supply gas in each of the first heat exchange operation, the second heat exchange operation, the third heat exchange operation, and the fourth heat exchange operation.

6. The method of claim 1, wherein the adjusting of the temperature of the first gas comprises, based on a temperature of the first gas generated in the reforming operation, controlling, with respective valves, flow rates of the supply gas supplied to a plurality of heat exchangers used in the heat exchange operation.

7. The method of claim 1, wherein the reforming temperature adjusting operation comprises:
determining whether a methane shift rate is lowered, by measuring a concentration of the methane in the first gas generated in the reforming operation; and
increasing, based on the methane shift rate being a preset value or less, a temperature of the reaction of methane and water in the reforming operation.

8. The method of claim 1, wherein the reforming temperature adjusting operation comprises:
increasing a temperature of the reaction of methane and water in the reforming operation based on a cumulative time of the reaction in the reforming operation being a preset value or more.

9. The method of claim 1, wherein the flow rate adjusting operation comprises adjusting a temperature of the first gas to 150° C. or more and 350° C. or less by adjusting, using the valve, a flow rate of the supply gas.

10. An apparatus for manufacturing hydrogen, the apparatus comprising:
reformer reaction vessels configured to generate, based on a reaction of methane and water, a first gas comprising hydrogen and carbon monoxide;
a water-gas shift reaction vessel configured to generate a second gas comprising hydrogen by reacting the carbon monoxide in the first gas with the water;
a plurality of heat exchangers configured to exchange heat between a portion of supply gas supplied to the reformer reaction vessels and the first gas supplied to the water-gas shift reaction vessel;
a temperature control circuit configured to control a methane shift rate by adjusting reaction temperatures in the reformer reaction vessels; and
a control circuit configured to control flow rates of supply gas supplied to the plurality of heat exchangers, respectively, by operating valves associated with the respective heat exchangers.

11. The apparatus of claim 10, wherein the control circuit is configured to adjust a temperature of the first gas supplied to the water-gas shift reaction vessel to 150° C. or more and 350° C. or less by controlling the flow rates of the supply gases supplied to the plurality of heat exchangers.

12. The apparatus of claim 10, wherein the plurality of heat exchangers comprise at least three heat exchangers.

13. The apparatus of claim 12, wherein the plurality of heat exchangers comprise:
a first heat exchanger configured to exchange heat between the first gas generated in the reformer reaction vessels and a portion of the supply gas supplied to the reformer reaction vessels;
a second heat exchanger configured to exchange heat between the heat-exchanged first gas generated in the first heat exchanger and a portion of the supply gas supplied to the reformer reaction vessels;
a third heat exchanger configured to exchange heat between the heat-exchanged first gas generated in the second heat exchanger and a portion of the supply gas supplied to the reformer reaction vessels; and
a fourth heat exchanger configured to exchange heat between the heat-exchanged first gas generated in the third heat exchanger and a portion of the supply gas supplied to the reformer reaction vessels.

14. The apparatus of claim 10, comprising:
a temperature sensor configured to measure a temperature of the first gas discharged from the reformer reaction vessels,
wherein the control circuit is configured to adjust, based on the measured temperature of the first gas, a temperature of the first gas supplied to the water-gas shift reaction vessel by controlling flow rates of supply gas supplied to the plurality of heat exchangers.

15. The apparatus of claim 10, comprising:
a gas sensor configured to measure a concentration of the methane, wherein the methane is in the first gas generated in the reformer reaction vessels.

16. The apparatus of claim 10, wherein the supply gas comprises water, or a mixture of water and methane.

17. An apparatus for hydrogen production, the apparatus comprising:
a reformer reaction vessel configured to receive a gas comprising methane and steam, and react the gas to produce a first gas comprising hydrogen, carbon monoxide, and at least a portion of the methane;
a sensor configured to determine that a methane-conversion rate has decreased, wherein the methane-conversion rate corresponds to a rate at which the methane in the gas is converted to the hydrogen and the carbon monoxide in the reformer reaction vessel;
a temperature control circuit configured to increase, based on a determination that the methane-conversion rate has decreased, a reaction temperature in the reformer reaction vessel;
a plurality of heat exchangers configured to receive the first gas from the reformer reaction vessel and transfer heat from the first gas to at least a portion of the gas, wherein the at least the portion of the gas is directed through the plurality of heat exchangers;
a flow control valve assembly coupled to the plurality of heat exchangers and configured to control, based on the reaction temperature in the reformer reaction vessel, a flow rate of the at least the portion of the gas directed through the plurality of heat exchangers; and
a water-gas shift reaction vessel configured to receive the first gas from the plurality of heat exchangers and convert carbon monoxide in the first gas to additional hydrogen.

18. The apparatus of claim 17, wherein the sensor is configured to determine, based on a concentration of the at least the portion of the methane in the first gas, the methane-conversion rate.

19. The apparatus of claim 17, wherein the sensor is configured to determine, based on a cumulative operating time of the reformer reaction vessel, the methane-conversion rate.

20. The apparatus of claim 17, wherein the temperature control circuit is further configured to increase, based on a concentration of the at least the portion of the methane in the first gas exceeding a predetermined threshold, the reaction temperature in the reformer reaction vessel.
